(19) United States
(12) Patent Application Publication
(10) Pub. No.: US 2008/0158618 A1
(43) Pub. Date: Jul. 3, 2008

(54) DUAL PAGE, APEX-BED SCANNER

(75) Inventors: Lowell J. Reese, Lindon, UT (US); James W. McElwee, Provo, UT (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Generations Network, Inc., Provo, UT (US)

(21) Appl. No.: 11/617,466

(22) Filed: Dec. 28, 2006

(51) Int. Cl. H04N 1/04

(52) U.S. Cl. 358/474

(57) ABSTRACT

An image capture device includes a scanning bed having transparent first and second scanning surfaces. The first and second scanning surfaces intersect to form an apex. The apex is configured to engage a bound document. The device also includes first and second scanners, each configured for movement along interior sides of the respective first and second scanning surfaces. The first and second scanners are configured to collect image information from the facing pages as the scanners move along the interior sides of the scanning surfaces and convert the image information to respective first and second electronic signals representative of distinct ones of the facing pages. The device also includes a data assembly arrangement configured to receive the first and second electronic signals and assemble the electronic signals into an image file representative of the facing pages according to user-defined preferences.

Embodiments of the invention relate generally to image capture devices. More specifically, embodiments of the invention related to devices for converting bound documents to electronic images of the documents.

### BACKGROUND OF THE INVENTION

Scanners, copiers, and facsimile machines are well known devices for converting a hard copy document, picture, or the like to an electronic reproduction of the source. The resulting electronic “document” may be thereafter processed in any of a number of well known ways.

The aforementioned image capture devices typically include a document feeder into which a source document is inserted for scanning or a scanning bed onto which a source document is placed for scanning. Neither of these solutions are desirable, however, for bound material.

Books are difficult to reproduce using known scanning and copying devices for a number of reasons. First, known scanners can only scan one book page at a time. This takes more time for scanning each page individually and more time to handle the book to place each page in the scanning position. Further, repeated handling of the book may cause damage to the book, especially to older books with fragile bindings. Further still, pressing or flattening a book so that the gutter portion is accessible can cause damage to the book. The inability to place the gutter portion of the book in contact with a scanning surface may introduce distortion in the reproduced image, especially for content that “bleeds” across the gutter. Even further still, known scanners and copiers provide no means for registering, or aligning, individually-scanned pages. Hence, improved image capture devices are needed that overcome the limitations of the prior art with respect to scanning or copying bound material.

### BRIEF SUMMARY OF THE INVENTION

Embodiments of the invention provide an image capture device. The device includes a scanning bed having transparent first and second scanning surfaces. Each of the first and second scanning surfaces has an exterior side and an opposing interior side. The first and second scanning surfaces intersect to form an apex. The apex is configured to engage a bound document to thereby place facing pages of the bound document in contact with respective exterior sides of the first and second scanning surfaces. The device also includes first and second scanners, each configured for movement along the interior sides of the respective first and second scanning surfaces. The first and second scanners are configured to collect image information from the facing pages as the scanners move along the interior sides of the scanning surfaces and convert the image information to respective first and second electronic signals representative of distinct ones of the facing pages. The device also includes a data assembly arrangement configured to receive the first and second electronic signals and assemble the electronic signals into an image file representative of the facing pages according to user-defined preferences.

In some embodiments, the image capture device is a scanner, a copier, and/or a facsimile machine. The first and second scanners may be charge-coupled device scanners. In assembling the electronic signals into an image file representative of the facing pages according to user-defined preferences, the data assembly arrangement may be configured to assemble the electronic signals into an image file representative of the facing pages being in a side-by-side arrangement. In assembling the electronic signals into an image file representative of the facing pages according to user-defined preferences, the data assembly arrangement may be configured to assemble the electronic signals into an image file representative of the facing pages being in a consecutive page arrangement. The image file may be a .pdf file, a .gif file, a .tiff file, and/or the like. The apex may have an angle of 110 degrees. The first and second surfaces may be adjustable with respect to one another to thereby change the angle of the apex.

Other embodiments provide a method of creating an image file. The image file includes facing pages of a bound document. The method includes providing an image capture device having a scanning bed with transparent first and second scanning surfaces. The first and second scanning surfaces intersect to form an apex. The apex is configured to engage the bound document to thereby place the facing pages of the bound document in contact with the first and second surfaces. The method also includes placing the bound document on the scanning bed of the image capture device, whereby a first facing page is in contact with the first scanning surface and the second facing page is in contact with the second scanning surface. The method also includes simultaneously scanning the first and second pages using independent scanners to thereby capture images of the first and second pages. The method also includes receiving a user command that is indicative of how the first and second page images are to be rendered with respect to one another in the image file. The method further includes placing the first and second page images into the image file according to the user command and thereafter displaying the first and second page images in accordance with the user command.

In some embodiments, the user command indicates that the first and second page images are to be rendered side-by-side in the image file. Simultaneously scanning the first and second pages using independent scanners to thereby capture images of the first and second pages may include scanning a gutter portion of each page. Placing the first and second page images into the image file according to the user command may include joining the first and second pages along respective gutter portions to thereby create a single page image comprising the first and second page images. The user command may indicate that the first and second page images are to be rendered one after the other in the image file. Receiving a user command that is indicative of how the first and second page images are to be rendered with respect to one another in the image file may include receiving the user command via software installed on a user computer in communication with the image capture device. Receiving a user command that is indicative of how the first and second page images are to be rendered with respect to one another in the image file may include receiving the user command via user controls of the image capture device.

Still other embodiments provide a scanner having a dual-page scanning bed having transparent first and second scanning surfaces. Each of the first and second scanning surfaces has an exterior side and an opposing interior side. The first and second scanning surfaces intersect to form an apex. The apex has an angle approximately equal to 110 degrees. The apex is configured to engage a bound document to thereby place facing pages of the bound document in contact with respective exterior sides of the first and second scanning surfaces. The scanner also includes first and second linear strip charge-coupled device scanners. Each is configured for movement along the interior sides of the respective first and second scanning surfaces. The first and second scanners are configured to collect image information from the facing pages as the scanners move along the interior sides of the scanning surfaces and convert the image information to respective first and second electronic signals representative of distinct ones of the facing pages. The scanner also includes data assembly means configured to receive the first and second electronic signals and assemble the electronic signals into an image file representative of the facing pages according to user-defined preferences.

In some embodiments, the data assembly means includes means for assembling the electronic signals into an image file representative of the facing pages being in a side-by-side arrangement. The data assembly means may include means for assembling the electronic signals into an image file representative of the facing pages being in a consecutive page arrangement. The image file may be a .pdf file, a .gif file, a .tiff file, or the like.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 depicts a perspective view of an exemplary dual page, apex-bed scanner according to embodiments of the invention.

FIG. 2 depicts a side view of the scanner of FIG. 1.

FIG. 3 depicts an exploded view of the scanner of FIG. 1.

FIG. 4 depicts a electrical block diagram of an exemplary scanner according to embodiments of the invention, the components of which may be included in the scanner of FIG. 1.

FIG. 5 depicts an exemplary method of capturing an image of a bound document according to embodiments of the invention, which method may be implemented in the scanner of FIG. 1.

### DETAILED DESCRIPTION OF THE INVENTION

Embodiments of the present invention relate to systems for converting tangible source material (bound document pages, bound book pages, bound photograph albums, and the like, hereinafter “books”) to electronic images. In order to provide a context for describing embodiments of the present invention, embodiments of the invention will be described herein with reference to scanning books. Those skilled in the art will appreciate, however, that other embodiments are possible. For example, embodiments of the invention may be used to copy books, fax books, and the like.

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is to be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems may be shown in block diagrams in order not to obscure the embodiments in unnecessary detail. In other instances, well-known processes, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

According to embodiments of the present invention, a scanner includes a dual page, apex bed onto which a book may be placed to thereby simultaneously scan facing pages. The pages may be thereafter electronically assembled according to user preferences and stored as any of a number of electronic file types.

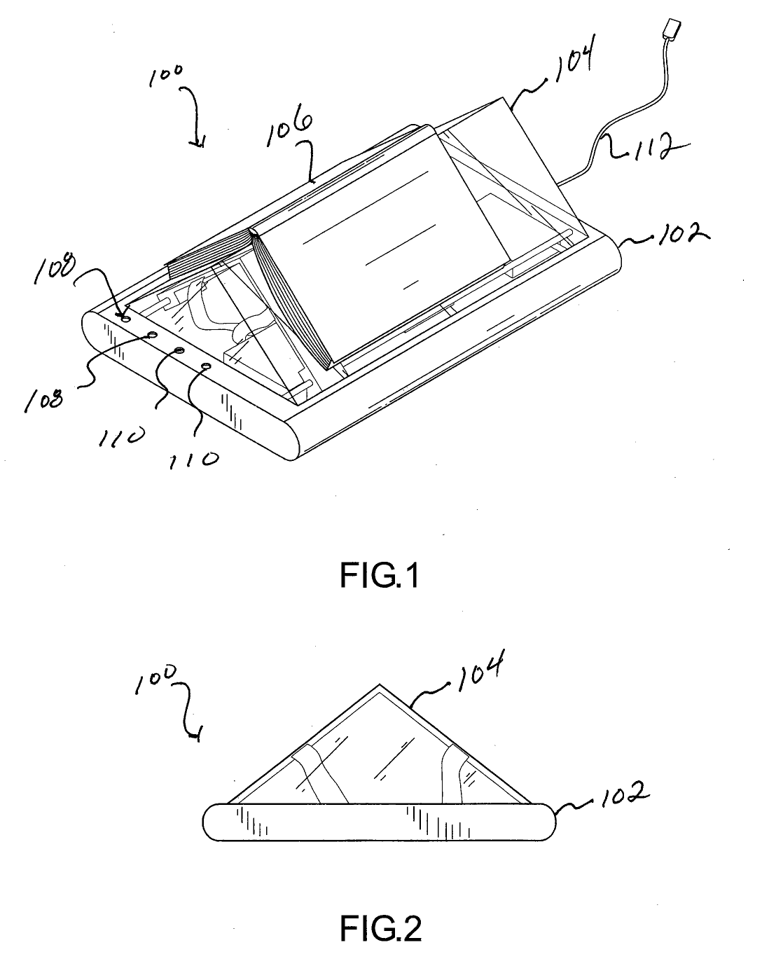

Having described embodiments of the invention generally, attention is directed to FIGS. 1 and 2, which depict an exemplary dual page, apex-bed scanner 100 according to embodiments of the invention. Those skilled in the art will appreciate that the scanner 100 is merely exemplary of a number of possible scanner embodiments. Moreover, those skilled in the art will appreciate that the teachings herein may be applicable to copiers, facsimile machines, and other image capture devices. For example, as will become apparent, an appropriate printing mechanism may be added to the scanner 100 to create a copier. Or appropriate communication hardware and/or software may be added to the scanner 100 to create a facsimile machine.

The scanner 100 includes a base 102 and a scanning bed 104. The scanning bed 104 forms an apex that provides a convenient surface for engaging a book 106 for scanning. According to embodiments of the invention, the scanner 100 allows book 106 pages to be scanned without stressing the binding of the book. Moreover, multiple pages of the book 106 may be scanned simultaneously.

The scanner 100 also includes indicator lights 108 and operational control buttons 110. The indicator lights 108 provide a visual indicator of the operational status of the scanner. The operational control buttons 110 provide direct user interface to the operational modes of the scanner that allow the user to, for example, initiate scanning, vary contrast, turn power off, and/or the like.

The scanner also includes an interface cable 112 through which the scanner 100 may be interfaced to a user computer, a network, another computer peripheral device, and/or the like. The interface cable may be any of a variety of well-known interface cables, such as USB 2.0, FireWire, and the like. In some embodiments, the scanner is configured for wireless communication, thereby eliminating the need for a wired connection. The scanner also includes a power interface (not shown).

As will be described in greater detail hereinafter, the scanner may be interfaced to a user computer having software thereon that “drives” the scanner. Through an appropriate user interface, the user may select various features or modes of operation for the scanner. For example, the user may elect color, grayscale, or monotone scanning, a scanning size and resolution, a scanning contrast, and/or the like. The user also may select whether to scan only one or the other of the facing pages of the book being scanned. The user also may select a file type (e.g., .pdf, .gif, .tiff, etc.) for an electronic file to be created of the scanned image.

In a specific embodiment, the user may select how the two facing pages of the book are to be arranged in the resulting electronic file. For example, the user may elect that the images of the two pages be joined side-by-side so that when viewed through an appropriate viewer (e.g., Adobe Acrobat®) the pages are always next to one another. Or the user may elect that the two pages be joined consecutively so that one appears below the other when viewed using a viewer. In the latter example, the user also may select the order in which the pages are joined.

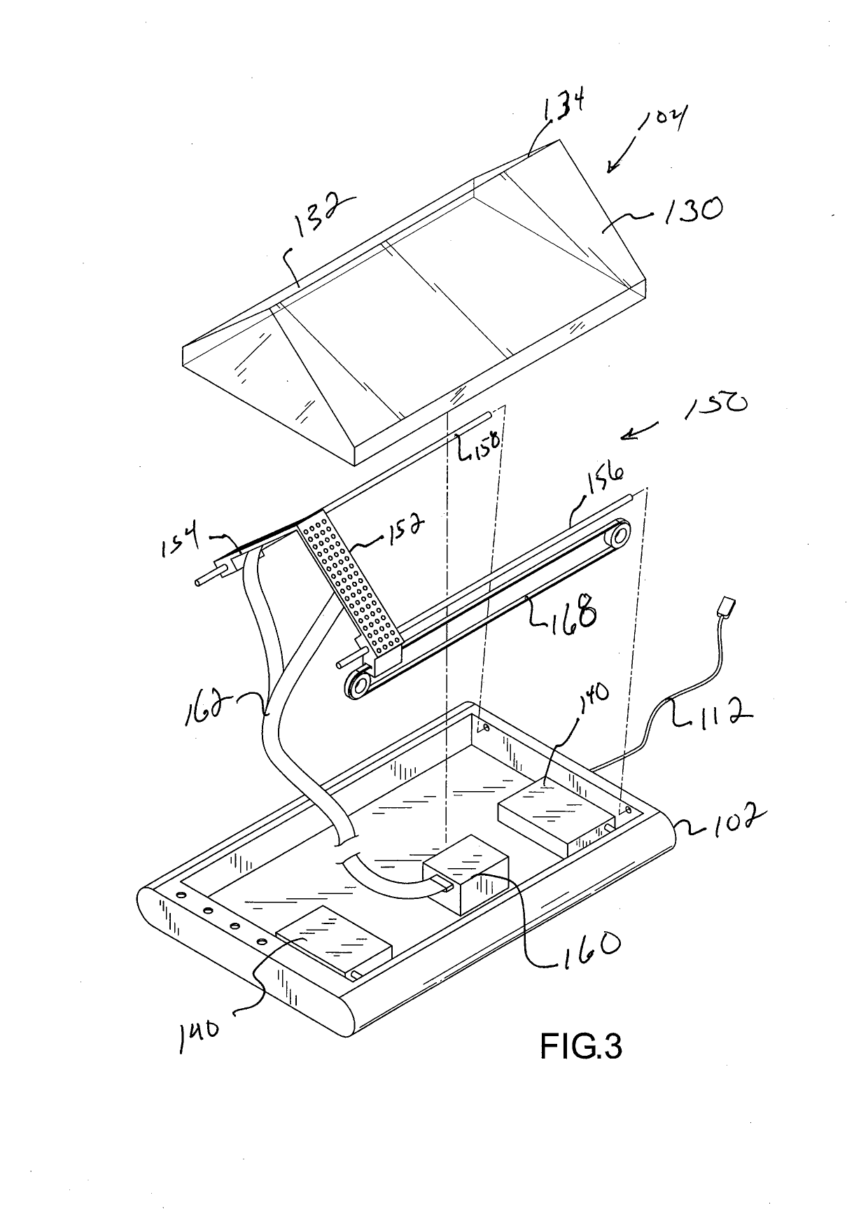

Directing attention to FIG. 3, further mechanical details of the scanner 100 will be described. The scanning bed 104 has first and second surfaces, referred to herein as right surface 130 and left surface 132. The surfaces 130, 132, are transparent and form an apex 134 having an angle. In a specific embodiment the angle is 110 degrees, although the angle is different in other embodiments. In some embodiments, the surfaces 130, 132 are adjustable with respect to one another to thereby change the angle of the apex. This is convenient, for example, to accommodate various types of books having different types of bindings, some of which may not open to 110 degrees or whatever angle the apex may be fixed, in such embodiments.

The base houses one or more drive motors 140 that operate a scanning apparatus 150, which will be explained in greater detail hereinafter. The base 140 also houses an electronics package 160 that receives signals from the scanning apparatus 150 and operates on those signals according to user preferences.

The scanning apparatus 150 includes first and second scanners, referred to herein as right scanner 152 and left scanner 154. In this specific embodiment, the scanners 152, 154 comprise linear, charge-coupled device (CCD) image sensors, although other embodiments may employ any of a variety of image sensors. In some embodiments, each scanner 152, 154 includes a light source that provides sufficient illumination of the source for the image sensors employed by the scanner.

The scanners 152, 154 are transported along respective guides 156, 158 by a belt drive 168, although other embodiments may employ any of a variety of drive systems. The belt drive 168 is powered by the drive motor(s) 140.

In operation, the scanners 152, 154 are located in close relationship to interior sides of respective scanning surfaces 130, 132. The scanners are configured for movement along the interior sides of the scanning surfaces to thereby simultaneously scan images from respective right and left facing pages of a book, which book pages are placed against the exterior sides of the scanning surfaces as shown in FIG. 1. As the respective left and right pages are scanned, image information collected by the scanners 152, 154 is converted into electrical signals that are transported along a ribbon cable 162, or other appropriate interface, to the electronics package 160 for further processing.

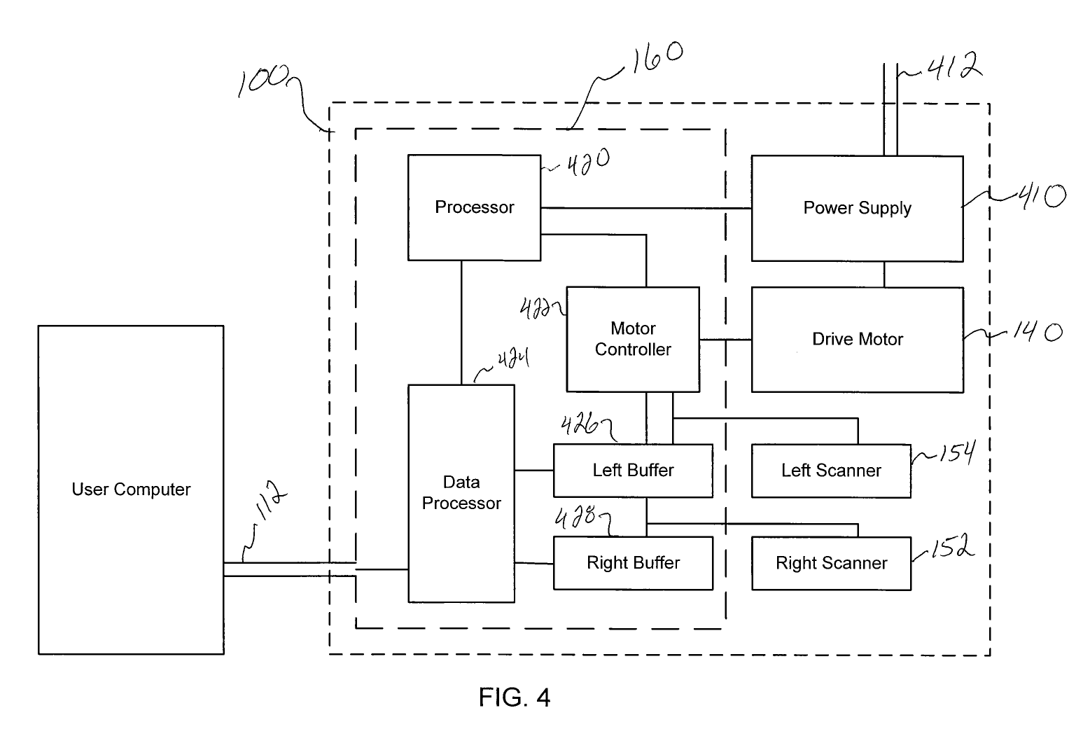

Attention is directed to FIG. 4, which depicts a block diagram 400 of the electrical components of the scanner 100 according to embodiments of the invention. Those skilled in the art will appreciate that this block diagram is merely exemplary of a number of possible embodiments. The block diagram 400 includes the drive motor 140, the right scanner 152, the left scanner 154, the electronics package 160, and a power supply 410. The block diagram also depicts the interface cable 112 and a user computer to which the scanner 100 is connected.

The power supply 410 receives external electrical power (e.g., 120 VAC) via a power cable 412 and converts the power for use by other components. The drive motor 140 receives power from the power supply 410 and also receives drive signals from the electronics package that provide the timing and alignment controls over the drive motor 140.

The electronics package 160 includes a processor 420, a motor controller 422, a data processor 424, a left buffer 426, and a right buffer 428. The processor 420 receives instructions from various user interfaces (e.g., a GUI operating on the user computer, a control panel of the scanner, etc.) and controls the operation of the other scanner components. For example, the processor 420 controls the scanning process by sending timing signals to the motor controller 422, which operates the drive motor 140. In this way, the processor 420 may cause timing and indexing references to be appended to, or otherwise included in, image information.

The processor 420 also instructs the data processor 424 on how the image information received from the scanners 152, 154 should be assembled into an image file. As image information is collected by the right 152 and left scanners 154, the image information may be buffered into respective right 428 and left 426 buffers. The image information may thereafter be assembled side-by-side, sequentially, or the like. For example, if a user desires that the facing pages of the book being scanned always appear next to one another, the processor 420 will instruct the data processor 424 to join corresponding lines together as they are read out of the right and left buffers 428, 426. Timing and index information recorded during scanning may be useful in this regard. If, however, a user desires to have one page sequentially follow the other page, then the processor 420 will instruct the data processor 424 to create a page from all lines of one buffer, then append all the lines of the other buffer into a subsequent page. Those skilled in the art will appreciate that the block diagram 400 of the electronics components of the scanner is merely exemplary of a number of possible embodiments.

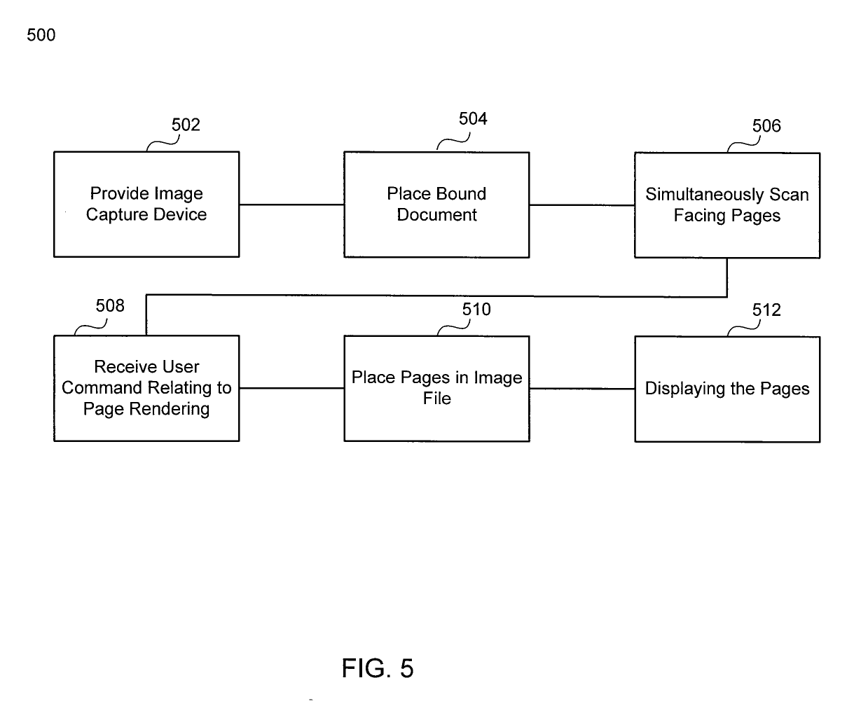

Having described several exemplary device embodiments, attention is directed to FIG. 5, which illustrates an exemplary method 500 according to embodiments of the invention. The method 500 may be implemented in the scanner 100 of FIG. 1 or other appropriate device. Those skilled in the art will appreciate that the method 500 is merely exemplary of a number of possible embodiments. Other embodiments may include more, fewer, or different steps than those illustrated and described herein. Moreover, those skilled in the art will appreciate that the steps illustrated and described herein may be traversed in orders different than those illustrated and described herein.

The method 500 begins at block 502, at which location an image capture device is provided. The image capture device may be, for example, the scanner 100 of FIG. 1. In other embodiments, the image capture device may be a copier, a fax machine, a multi-function device, or the like. The image capture device has an apex-bed that is configured to support a bound document to thereby scan facing pages of the bound document simultaneously. In a specific embodiment, the image capture device includes dual linear strip, CCD scanners driven by a common drive motor to thereby capture corresponding portions of each of two facing pages being scanned simultaneously.

At block 504, a user places a bound document on the scanning bed. Conveniently, the apex-bed configuration supports most bound documents such that the facing pages are in contact with the scanning bed surfaces. At block 506, facing pages of the bound document are simultaneously scanned. The image information from the facing pages may be independently buffered, and timing and indexing information may be included in the image information for later use during image file assembly.

At block 508, the image capture device receives users commands indicative of how the facing pages are to be rendered in an image file. The user commands may be received from software (e.g., a “driver”) installed on a user computer in communication with the image capture device. In other embodiments, the user command may be received from user controls on the image capture device itself. The user may, for example, indicate that the pages are to appear side-by-side, sequentially, etc. In some embodiments, the user may select that the two facing pages appear as a single page, seamlessly joined along a gutter portion of each page. In some embodiments the user is able to select whether to image just one or the other of the pages.

At block 510, a corresponding image file is created from the independently buffered image information from each of the two facing pages. The pages may be included in a larger file having any number of pages from the same or different bound documents. The pages are rendered in the image file according to the user selections. Thereafter, the image file may be used to display the pages using an appropriate viewer, print the pages, transmit the pages, duplicate the pages, and the like.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the will appreciate that the teachings herein may be applied to copy machines, facsimile machines, and the like. Accordingly, the above description should not be taken as limiting the scope of the invention, which is defined in the following claims.

What is claimed is:

1. An image capture device, comprising:
a scanning bed having transparent first and second scanning surfaces, each of the first and second scanning surfaces having an exterior side and an opposing interior side, wherein the first and second scanning surfaces intersect to form an apex, the apex being configured to engage a bound document to thereby place facing pages of the bound document in contact with respective exterior sides of the first and second scanning surfaces;
first and second scanners each configured for movement along the interior sides of the respective first and second scanning surfaces, wherein the first and second scanners are configured to collect image information from the facing pages as the scanners move along the interior sides of the scanning surfaces and convert the image information to respective first and second electronic signals representative of distinct ones of the facing pages;
a data assembly arrangement configured to receive the first and second electronic signals and assemble the electronic signals into an image file representative of the facing pages according to user-defined preferences.

2. The image capture device of claim 1, wherein the image capture device comprises a selection from a group consisting of scanner, copier, and facsimile machine.

3. The image capture device of claim 1, wherein the first and second scanners comprise charge-coupled device scanners.

4. The image capture device of claim 1, wherein in assembling the electronic signals into an image file representative of the facing pages according to user-defined preferences, the data assembly arrangement is configured to assemble the electronic signals into an image file representative of the facing pages being in a side-by-side arrangement.

5. The image capture device of claim 1, wherein in assembling the electronic signals into an image file representative of the facing pages according to user-defined preferences, the data assembly arrangement is configured to assemble the electronic signals into an image file representative of the facing pages being in a consecutive page arrangement.

6. The image capture device of claim 1, wherein the image file comprises a selection from a group consisting of .pdf file, .gif file, and .tiff file.

7. The image capture device of claim 1, wherein the apex has an angle of 110 degrees.

8. The image capture device of claim 1, wherein the apex has an angle and wherein the first and second surfaces are adjustable with respect to one another to thereby change the angle of the apex.

9. A method of creating an image file comprising facing pages of a bound document, the method comprising:
providing an image capture device having a scanning bed with transparent first and second scanning surfaces, wherein the first and second scanning surfaces intersect to form an apex, the apex being configured to engage the bound document to thereby place the facing pages of the bound document in contact with the first and second surfaces;
placing the bound document on the scanning bed of the image capture device, whereby a first facing page is in contact with the first scanning surface and the second facing page is in contact with the second scanning surface;
simultaneously scanning the first and second pages using independent scanners to thereby capture images of the first and second pages;
receiving a user command that is indicative of how the first and second page images are to be rendered with respect to one another in the image file;
placing the first and second page images into the image file according to the user command; and
thereafter displaying the first and second page images in accordance with the user command.

10. The method of claim 9, wherein the user command indicates that the first and second page images are to be rendered side-by-side in the image file.

11. The method of claim 10, wherein simultaneously scanning the first and second pages using independent scanners to thereby capture images of the first and second pages comprises scanning a gutter portion of each page.

12. The method of claim 11, wherein placing the first and second page images into the image file according to the user command comprises joining the first and second pages along respective gutter portions to thereby create a single page image comprising the first and second page images.

13. The method of claim 9, wherein the user command indicates that the first and second page images are to be rendered one after the other in the image file.

14. The method of claim 9, wherein receiving a user command that is indicative of how the first and second page images are to be rendered with respect to one another in the image file comprises receiving the user command via software installed on a user computer in communication with the image capture device.

15. The method of claim 9, wherein receiving a user command that is indicative of how the first and second page images are to be rendered with respect to one another in the image file comprises receiving the user command via user controls of the image capture device.

16. A scanner, comprising:
a dual-page, scanning bed having transparent first and second scanning surfaces, each of the first and second scanning surfaces having an exterior side and an opposing interior side, wherein the first and second scanning surfaces intersect to form an apex, the apex having an angle approximately equal to 110 degrees, the apex being configured to engage a bound document to thereby place facing pages of the bound document in contact with respective exterior sides of the first and second scanning surfaces;
first and second linear strip charge-coupled device scanners, each configured for movement along the interior sides of the respective first and second scanning surfaces, wherein the first and second scanners are configured to collect image information from the facing pages as the scanners move along the interior sides of the scanning surfaces and convert the image information to respective first and second electronic signals representative of distinct ones of the facing pages;
data assembly means configured to receive the first and second electronic signals and assemble the electronic signals into an image file representative of the facing pages according to user-defined preferences.

17. The scanner of claim 16, wherein the data assembly means includes means for assembling the electronic signals into an image file representative of the facing pages being in a side-by-side arrangement.

18. The scanner of claim 16, wherein the data assembly means includes means for assembling the electronic signals into an image file representative of the facing pages being in a consecutive page arrangement.

19. The scanner of claim 16, wherein the image file comprises a selection from a group consisting of .pdf file, .gif file, and .tiff file.
